(19) United States
(12) Patent Application Publication
(10) Pub. No.: US 2025/0357746 A1
(43) Pub. Date: Nov. 20, 2025

(54) CUTOFF CONTROL DEVICE

(71) Applicants: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP)

(72) Inventor: Takafumi KAWAKAMI, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-shi, Mie (JP); Sumitomo Electric Industries, Ltd., Osaka-Shi, Osaka (JP)

(21) Appl. No.: 18/873,899

(22) PCT Filed: Jun. 15, 2022
(86) PCT No.: PCT/JP2022/023940

§ 371 Date: Dec. 11, 2024

(51) Int. Cl. H02H 3/38; H02H 3/10; H02H 3/24; H02H 7/18

(52) U.S. Cl. CPC H02H 3/38; H02H 3/10; H02H 3/24; H02H 7/18

(57) ABSTRACT

A cutoff control device controls a cutoff unit. An in-vehicle system includes a power storage unit, a power line for power transmission between the power storage unit and a load, and a cutoff unit to switch between allowing and cutting off power supply from the power storage unit to the load through the power line. The cutoff control device includes a current detection unit, a voltage detection unit, and a control unit. The current detection unit detects the current flowing through the power line. The voltage detection unit detects the voltage in the power line. The control unit instructs the cutoff unit to cut off power if the current detection unit detects a predetermined current increase and the voltage detection unit detects a predetermined voltage decrease.

### CROSS-REFERENCE TO RELATED APPLICATIONS

This application is the U.S. national stage of PCT/JP2022/023940 filed on Jun. 15, 2022, the contents of which are incorporated herein.

### TECHNICAL FIELD

The present disclosure relates to a cutoff control device.

### BACKGROUND

WO 2021/010007A discloses a technique in which a current detection unit detects the magnitude of a current flowing through a power line and a control unit monitors a signal acquired from the current detection unit. If the control unit determines that the rate of change of the current flowing through the power line is greater than or equal to a specified value, the control unit outputs a cutoff signal to a relay unit or a cutoff unit provided in the power line to switch the relay unit or the cutoff unit to a cutoff state.

The technique disclosed in WO 2021/010007A determines whether to output the cutoff signal using only the signal acquired from the current detection unit. Accordingly, if noise occurs in the power line, the control unit in WO 2021/010007A may erroneously determine the noise as a change in current and output the cutoff signal. A technique to prevent such erroneous determination is desired.

The present disclosure has been made in view of the above-described circumstances, and has an object of providing a cutoff control device that can appropriately cut off a power line.

### SUMMARY

A cutoff control device according to the present disclosure is a cutoff control device that is for use in an in-vehicle system including: a power storage unit; a power line as a path through which power is transmitted between the power storage unit and a load; and a cutoff unit configured to switch from an allowed state in which power supply from the power storage unit to the load through the power line is allowed to a cutoff state in which the power supply is cut off, and that is configured to control the cutoff unit, the cutoff control device including: a current detection unit configured to detect a current state of a current flowing through the power line; a voltage detection unit configured to detect a voltage state of a voltage in the power line; and a control unit configured to instruct the cutoff unit to switch to the cutoff state if the current state detected by the current detection unit is a predetermined current increase state and the voltage state detected by the voltage detection unit is a predetermined voltage decrease state.

### Advantageous Effects

According to the present disclosure, it is possible to appropriately cut off a power line.

### BRIEF DESCRIPTION OF DRAWINGS

FIG. 1 is a block diagram showing an example of an in-vehicle system including a cutoff control device according to Embodiment 1.

FIG. 2 is a graph showing a region where a state is a current increase state and a voltage decrease state.

FIG. 3 is a graph showing an example of a sudden increase in current flowing through a power line when the power line has a ground fault.

FIG. 4 is a flowchart showing a process by a control unit according to Embodiment 1.

FIG. 5 is a block diagram showing an example of an in-vehicle system including a cutoff control device according to another embodiment.

### DETAILED DESCRIPTION OF PREFERRED EMBODIMENTS

First, embodiments of the present disclosure will be listed and described.

In a first aspect, a cutoff control device according to the present disclosure that is for use in an in-vehicle system and configured to control a cutoff unit. The in-vehicle system includes: a power storage unit; a power line as a path through which power is transmitted between the power storage unit and a load; and a cutoff unit configured to switch from an allowed state in which power supply from the power storage unit to the load through the power line is allowed to a cutoff state in which the power supply is cut off. The cutoff control device includes a current detection unit, a voltage detection unit, and a control unit. The current detection unit is configured to detect a current state of a current flowing through the power line. The voltage detection unit is configured to detect a voltage state of a voltage in the power line. The control unit is configured to instruct the cutoff unit to switch to the cutoff state if the current state detected by the current detection unit is a predetermined current increase state and the voltage state detected by the voltage detection unit is a predetermined voltage decrease state.

The cutoff control device according to the first aspect switches the cutoff unit to the cutoff state if both the current increase state and the voltage decrease state are recognized. Thus, the cutoff control device can more accurately determine whether a short-circuit current has occurred, and switch the cutoff unit to the cutoff state upon the occurrence of a short-circuit current. For example, in the case where whether a short-circuit current has occurred is determined based on only a current increase or a voltage decrease, noise or the like may cause erroneous cutoff. The cutoff control device can prevent such erroneous cutoff.

In a second aspect, in the cutoff control device according to the first aspect, the current detection unit may be configured to detect a first detection value with which a current value of the power line is identifiable, as the current increase state, and the voltage detection unit may be configured to detect a second detection value with which a voltage value of the power line is identifiable, as the voltage decrease state. The current increase state may be a state in which the current value of the power line is greater than or equal to a current threshold, and the voltage decrease state may be a state in which the voltage value of the power line is less than or equal to a voltage threshold.

The cutoff control device according to the second aspect can achieve both protection from short-circuit current and prevention of erroneous cutoff by a simple structure in which whether the current value of the power line is greater than or equal to the current threshold and whether the voltage value of the power line is less than or equal to the voltage threshold are determined based on the first detection value with which the current value is identifiable and the second detection value with which the voltage value is identifiable.

In a third aspect, the in-vehicle system may include a switch provided in the power line and configured to switch the power line between a conductive state and a non-conductive state, and the switch may be configured to, if a current greater than or equal to a predetermined value flows through the switch in the conductive state, be released from the conductive state and switch to the non-conductive state due to generation of an electromagnetic repulsive force. The current detection unit in the cutoff control device according to [1] may be configured to detect a first detection value with which a current value of the power line is identifiable, as the current increase state, the current increase state may be a state in which the current value of the power line is greater than or equal to a current threshold, and the current threshold may be a value less than the predetermined value.

The cutoff control device according to the third aspect can set the current threshold within the range in which switching to the non-conductive state due to an electromagnetic repulsive force does not occur.

In a fourth aspect, in the cutoff control device according to the first or the third aspect, the voltage decrease state may be a state in which a voltage decrease rate of the power line is greater than or equal to a certain value.

The cutoff control device according to the fourth aspect can switch the cutoff unit to the cutoff state when the voltage decrease rate is greater than or equal to the certain value in the current increase state. Thus, the cutoff control device can simultaneously achieve prompt protection from short-circuit current and prevention of erroneous cutoff.

In a fifth aspect, the in-vehicle system may include a measurement unit configured to measure an internal resistance value of the power storage unit. In the cutoff control device according to any one of the first through the third aspects, the voltage decrease state may be a state in which a voltage value of the power line is less than or equal to a voltage threshold, and the control unit may be configured to, based on the internal resistance value measured by the measurement unit, set the voltage threshold to be lower when the internal resistance value is larger.

The cutoff control device according to the fifth aspect can, based on the premise that the internal resistance value of the power storage unit is actually measured, set the voltage threshold according to the actual internal resistance value so that the voltage threshold will be lower when the actual internal resistance value is larger.

In a sixth aspect, in the cutoff control device according to the second or the third aspect, the voltage decrease state may be a state in which the voltage value of the power line is less than or equal to the voltage threshold. Based on a multiplication value and an output voltage of the power storage unit, the voltage threshold may be determined according to an arithmetic equation that sets the voltage threshold to be higher when the output voltage is larger and to be lower when the multiplication value is larger. The multiplication value is obtained by multiplying a sum of an internal resistance value of the power storage unit and a resistance value of the power line by the current threshold.

The cutoff control device according to the sixth aspect can appropriately set the voltage threshold by reflecting the internal resistance value, the resistance value of the power line, the current threshold, and the output voltage of the power storage unit.

In a seventh aspect, the in-vehicle system may include a switch provided in the power line and configured to switch the power line between a conductive state and a non-conductive state. In the cutoff control device according to any one of the first through the third aspects, the voltage detection unit may be configured to detect the voltage state on a side closer to the load than the switch.

The cutoff control device according to the seventh aspect can suppress the flow of dark current based on the power storage unit to the voltage detection unit when the switch is in the non-conductive state. This leads to power saving.

In an eighth aspect, the in-vehicle system may include a switch provided in the power line and configured to switch the power line between a conductive state and a non-conductive state. In the cutoff control device according to any one of the first through the third aspects, the voltage detection unit may be configured to detect the voltage state on a side closer to the power storage unit than the switch.

The cutoff control device according to the eighth aspect can easily detect the voltage state at a position closer to the power storage unit, and therefore can detect the voltage state of the power storage unit while excluding a voltage drop that occurs in the power line as much as possible.

In a ninth aspect, in the cutoff control device according to any one of the first through the eighth aspects, any of a pyrofuse, an electromagnetic fuse, and a semiconductor switch may be used in the cutoff unit.

The cutoff control device according to the ninth aspect can easily perform switching to the cutoff state in a short time.

### Embodiment 1

An in-vehicle system 10 including a cutoff control device 30 according to Embodiment 1 is an in-vehicle power supply system, and includes a power storage unit 91, a power line 31, a cutoff unit 34, a relay 36 as a switch, a measurement unit 37, and the cutoff control device 30. The cutoff control device 30 includes a current detection unit 38, a voltage detection unit 39, and a control unit 20. The cutoff control device 30 is used in the in-vehicle system 10, and has a function of controlling the cutoff unit 34. The in-vehicle system 10 is configured to apply a voltage from the power storage unit 91 to a load 94 through the power line 31 which is a path for transmitting power between the power storage unit 91 and the load 94.

Overview of in-Vehicle System

The power storage unit 91 is a DC power source that generates a DC voltage. For example, a power source such as a lead battery, LiB, alternator, or converter is used. The power storage unit 91 includes a high-potential side terminal and a low-potential side terminal. The power storage unit 91 is configured to apply a predetermined output voltage to the power line 31.

The power line 31 includes a high-potential side power line 31A and a low-potential side power line 31B. The high-potential side terminal of the power storage unit 91 is electrically connected to the high-potential side power line 31A. The low-potential side terminal of the power storage unit 91 is electrically connected to the low-potential side power line 31B. The power storage unit 91 generates a predetermined potential difference (i.e., the output voltage of the power storage unit 91) between the high-potential side power line 31A and the low-potential side power line 31B. The power line 31 is a path through which power is transmitted between the power storage unit 91 and the load 94.

The high-potential side power line 31A is electrically connected to a positive electrode of the load 94. The low-potential side power line 31B is electrically connected to a negative electrode of the load 94.

The load 94 is an in-vehicle electronic component, and examples thereof include products such as electric components, ECUs, and ADAS-related components. The load 94 is electrically connected to the power line 31.

In the present disclosure, the expression “electrically connected” desirably refers to a structure in which two objects are connected in a conductive state (i.e., a state in which current can flow) so that the respective potentials of the two connected objects will be equal. However, the expression “electrically connected” is not limited to this structure. For example, the expression “electrically connected” may refer to a structure in which two objects are connected in a conductive state with another electric component interposed therebetween.

The cutoff unit 34 uses, for example, a pyrofuse (registered trademark). The cutoff unit 34 is provided in the low-potential side power line 31B. When a drive signal D is provided from the below-described control unit 20, the cutoff unit 34 switches from an allowed state in which power supply from the power storage unit 91 to the load 94 through the power line 31 is allowed to a cutoff state in which the power supply is cut off, and stops the power supply from the power storage unit 91 to the load 94.

When the drive signal D is provided to the pyrofuse, for example, gunpowder provided inside the pyrofuse ignites, and the explosive force of the gunpowder instantly divides the conductive path in the pyrofuse that electrically connects the power line 31 on the power storage unit 91 side and the power line 31 on the load 94 side, thereby producing the cutoff state. Thus, the pyrofuse can cut off the power line 31 in a shorter time than a relay or the like. The cutoff unit 34 that has switched to the cutoff state does not switch from the cutoff state to the allowed state.

The relay 36 includes a high-potential side relay 36A and a low-potential side relay 36B. For example, a contactor or a mechanical relay is used for each of the high-potential side relay 36A and the low-potential side relay 36B. The high-potential side relay 36A is provided in the high-potential side power line 31A. The low-potential side relay 36B is provided in the low-potential side power line 31B on the side closer to the load 94 than the cutoff unit 34. When a cutoff signal C3 is provided from the control unit 20, the high-potential side relay 36A and the low-potential side relay 36B switch to a non-conductive state. When a conduction signal C4 is provided from the control unit 20, the high-potential side relay 36A and the low-potential side relay 36B switch to a conductive state. Thus, the relay 36 is provided in the power line 31, and switches each of the high-potential side power line 31A and the low-potential side power line 31B between the conductive state and the non-conductive state.

The measurement unit 37 is an in-vehicle battery monitoring device, and can function as a battery management system (BMS) that monitors and manages the power storage unit 91. The measurement unit 37 can also function as a battery sensing unit (BSU) that measures the voltage, current, temperature, etc. related to the power storage unit 91. The measurement unit 37 is configured to calculate the internal resistance value R0 of the power storage unit 91 based on the measured voltage, current, temperature, etc. related to the power storage unit 91 and output this internal resistance value R0. For example, the internal resistance value R0 of the power storage unit 91 gradually increases as discharging from the power storage unit 91 progresses, and gradually decreases as charging progresses.

The current detection unit 38 is provided in the low-potential side power line 31B on the side closer to the power storage unit 91 than the cutoff unit 34. The current detection unit 38 includes, for example, a resistor and a differential amplifier, and is configured to output a value indicating the current flowing through the low-potential side power line 31B (specifically, an analog voltage corresponding to the value of the current flowing through the low-potential side power line 31B) as a first detection value A. In other words, the current detection unit 38 detects the current state of the current flowing through the power line 31 as the first detection value A.

The voltage detection unit 39 is, for example, part of the below-described control unit 20. The voltage detection unit 39 is configured to obtain a second detection value V corresponding to the potential difference between the high-potential side power line 31A and the low-potential side power line 31B (i.e., the voltage value of the power line 31). In other words, the voltage detection unit 39 detects the voltage state of the voltage in the power line 31 as the second detection value V. The voltage detection unit 39 detects the voltage state on the side closer to the power storage unit 91 than the relay 36. For example, the voltage detection unit 39 is configured to calculate the second detection value V at predetermined short time intervals. The control unit 20 is configured to store the second detection value V previously calculated by the voltage detection unit 39 as a second detection value V0 in a storage region 20A in the control unit 20. The second detection values V and V0 correspond to the output voltage of the power storage unit 91.

The control unit 20 performs control to instruct the cutoff unit 34 to switch to the cutoff state. The control unit 20 is composed of, for example, circuitry and components capable of control, such as a microcomputer, FPGA, etc. The control unit 20 is configured to receive the internal resistance value R0 of the power storage unit 91 from the measurement unit 37. The control unit 20 is also configured to receive the first detection value A from the current detection unit 38. The control unit 20 can execute determination control to determine whether to switch the cutoff unit 34 to the cutoff state based on the first detection value A, the internal resistance value R0, and the second detection values V and V0. The first detection value A is received from the current detection unit 38. The internal resistance value R0 is received from the measurement unit 37. The second detection value V is obtained by the voltage detection unit 39. The second detection value V0 is stored in the storage region 20A.

### Determination Control

The determination control in the control unit 20 will be described. For example, when a ground fault occurs in any of the power lines 31, the current flowing through the power line 31 increases rapidly over time, and as a result the first detection value A increases rapidly over time. When the first detection value A becomes greater than or equal to a current threshold Ath that is greater than a first threshold Th1 and less than a second threshold Th2, the control unit 20 determines that a state of the in-vehicle system is a current increase state. When the second detection value V becomes less than or equal to a voltage threshold Vth, the control unit 20 determines that a state of the in-vehicle system is a voltage decrease state. When the control unit 20 determines that the state of the in-vehicle system is the current increase state and the voltage decrease state, the control unit 20 outputs the drive signal D to the cutoff unit 34.

### First Threshold, Second Threshold, and Current Threshold

The first threshold Th1 corresponds to the maximum current value that can flow through the power line 31 when the power line 31 is in a normal state. Herein, the term “normal state” is, for example, a state in which the voltage value in the power line 31 is a predetermined value greater than or equal to 0 V (i.e., a state in which the power line 31 has no ground fault). The maximum current value that can flow through the power line 31 is assumed to be, for example, the current that flows through the power line 31 in the case where the load 94, such as a motor in a vehicle, is operated to the maximum.

The second threshold Th2, which is a predetermined value, corresponds to the maximum current value at which the relay 36 can maintain the cutoff state. The second threshold Th2 is greater than the first threshold Th1. When the current flowing through the power line 31 flows into the relay 36, an electromagnetic repulsive force is generated in the relay 36 so as to change the relay 36 from the conductive state to the non-conductive state. This electromagnetic repulsive force increases according to the magnitude of the current flowing into the relay 36. When the current flowing into the relay 36 becomes greater than the second threshold Th2, the electromagnetic repulsive force exceeds the force of holding the relay 36 in the conductive state and the relay 36 changes to the non-conductive state, causing generation of an arc in the relay 36. This may cause a failure of the relay 36. Thus, the relay 36 is configured to, if a current greater than or equal to the predetermined value (the maximum current value at which the relay 36 can maintain the cut-off state (second threshold Th2)) flows through the relay 36 in the conductive state, be released from the conductive state and switch to the non-conductive state due to the generation of an electromagnetic repulsive force.

The current threshold Ath is a value used to determine whether the current state of the current flowing through the power line 31 detected by the current detection unit 38 is a predetermined current increase state. The current threshold Ath is set in a range greater than the first threshold Th1 and less than the second threshold Th2. If the first detection value A received from the current detection unit 38 is greater than the current threshold Ath, the control unit 20 determines that the state of the in-vehicle system is the current increase state (i.e., the condition for switching the cutoff unit 34 to the cut-off state is satisfied). In other words, the current increase state is a state in which the first detection value A of the power line 31 is greater than or equal to the current threshold Ath. The current detection unit 38 detects the first detection value A with which the current value of the power line 31 is identifiable, as the current increase state.

### Voltage Threshold

The voltage threshold Vth is a value used to determine whether the voltage state of the voltage in the power line 31 detected by the voltage detection unit 39 is a predetermined voltage decrease state. The control unit 20 determines the voltage threshold Vth based on the following Formula 1.

$$V th = V 0 - Ath \times ( R 0 + Rj ) \qquad Formula 1$$

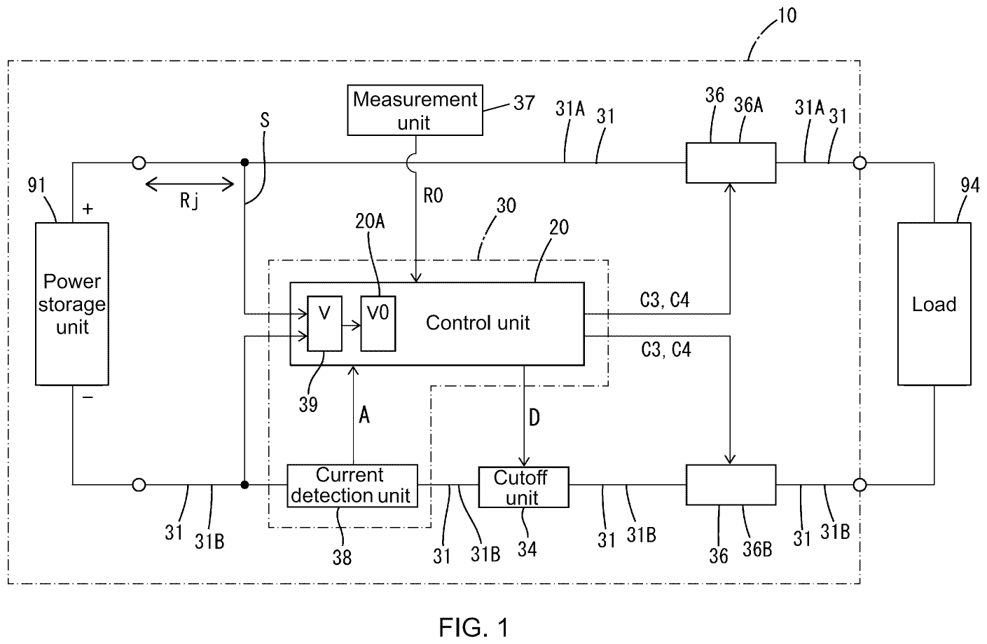

Here, V0 is the second detection value V0 previously calculated by the voltage detection unit 39 and then stored in the storage region 20A, Ath is the current threshold Ath, R0 is the internal resistance value R0 of the power storage unit 91 received from the measurement unit 37, and Rj is the resistance value Rj in the power line 31. As shown in FIG. 1, the resistance value Rj is the resistance value in the high-potential side power line 31A from the position where the high-potential side terminal of the power storage unit 91 is connected to the position where a signal line S of the voltage detection unit 39 is connected to the high-potential side power line 31A. The voltage threshold Vth may be adjusted by adding a correction value to Formula 1 or weighting each value.

The voltage threshold Vth is determined according to the arithmetic equation of Formula 1 based on the multiplication value (Ath×(R0+Rj)) obtained by multiplying the sum of the internal resistance value R0 of the power storage unit 91 and the resistance value Rj of the power line 31 by the current threshold Ath and the second detection value V0 (the output voltage of the power storage unit 91). As shown in Formula 1, the voltage threshold Vth is higher when the second detection value V0 is larger, and lower when the multiplication value (Ath×(R0+Rj)) is larger. Based on the internal resistance value R0 measured by the measurement unit 37, the control unit 20 sets the voltage threshold Vth to be lower when the internal resistance value R0 is larger.

The control unit 20 compares the magnitude of the second detection value V calculated by the voltage detection unit 39 with the voltage threshold Vth, and determines that the state of the in-vehicle system is the voltage decrease state if the second detection value V is less than or equal to the voltage threshold Vth. In other words, the voltage decrease state is a state in which the second detection value V of the power line 31 is less than or equal to the voltage threshold Vth. The voltage detection unit 39 thus detects the second detection value V with which the voltage value of the power line 31 is identifiable, as the voltage decrease state.

If the control unit 20 determines that the current state detected by the current detection unit 38 is the predetermined current increase state and the voltage state detected by the voltage detection unit 39 is the predetermined voltage decrease state, the control unit 20 outputs the drive signal D to the cutoff unit 34 to instruct the cutoff unit 34 to switch to the cutoff state.

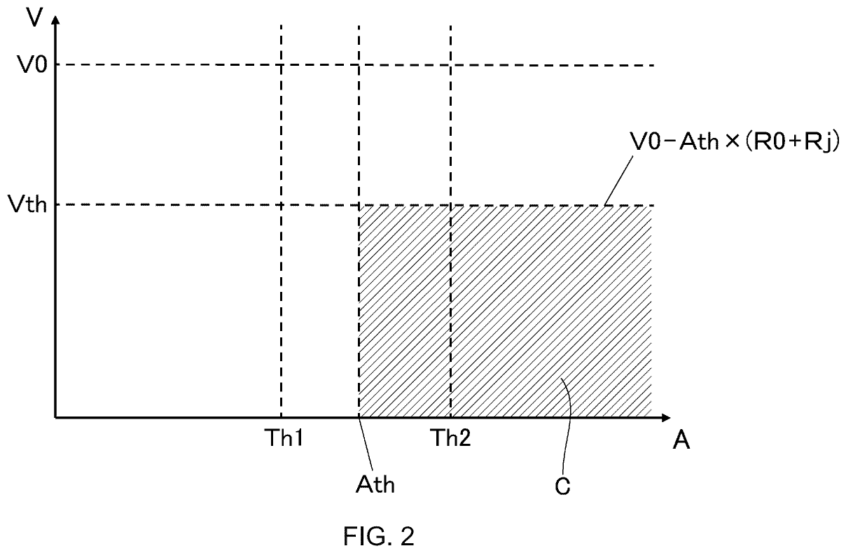

Specifically, if the determination result is in a region C satisfying the condition that the first detection value A is greater than or equal to the current threshold Ath and the second detection value V is less than or equal to the voltage threshold Vth as shown in FIG. 2, the control unit 20 outputs the drive signal D to the cutoff unit 34. The current threshold Ath is set to a range greater than the first threshold Th1 and less than the second threshold Th2. The current threshold Ath is set to a value less than the second threshold Th2. Hence, the cutoff unit 34 can be switched to the cutoff state before the electromagnetic repulsive force exceeds the force of holding the relay 36 in the conductive state (i.e., before the relay 36 fails).

### Time Until Cutoff Unit Switches to Cutoff State

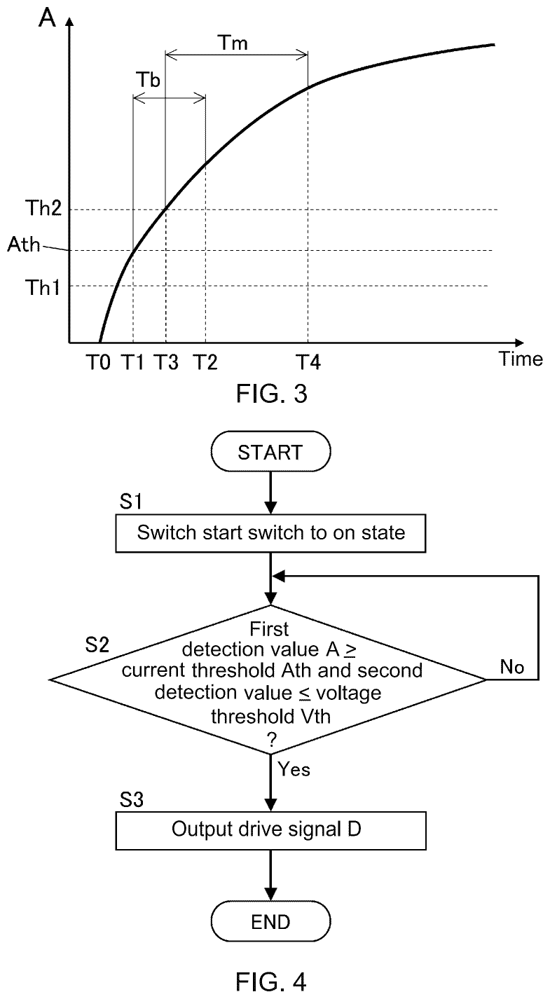

Next, the time until the cutoff unit 34 switches to the cutoff state in the case where a ground fault occurs in any of the power lines 31 and at the same time the second detection value V becomes less than or equal to the voltage threshold Vth (voltage decrease state) will be described. For example, as shown in FIG. 3, when a ground fault occurs in any of the power lines 31 at time T0, the current value of the current flowing through the power line 31 increases rapidly, and the first detection value A reaches the current threshold Ath at time T1. At this time, the state of the in-vehicle system is the current increase state and the voltage decrease state. The control unit 20 accordingly outputs the drive signal D to the cutoff unit 34 at time T1. Upon receiving the drive signal D, the cutoff unit 34 starts the operation of switching from the allowed state to the cutoff state. After time T1, the first detection value A (the current value of the current flowing through the power line 31) continues to increase.

Then, at time T2, the switching operation of the cutoff unit 34 to the cutoff state is completed. The time (time period) Tb from time T1 to time T2 can vary depending on the specifications of the control unit 20 and the cutoff unit 34. Times T1 and T2 are later when the current threshold Ath is set closer to the second threshold Th2, and earlier when the current threshold Ath is set closer to the first threshold Th1.

Time T4 can be defined, for example, by the maximum time (time period) Tm during which a current of a magnitude greater than or equal to the second threshold Th2 is allowed to flow through the relay 36, starting from time T3 at which the first detection value A reaches the second threshold Th2. For example, if the current continues to flow through the relay 36 for a time longer than the maximum time Tm, the possibility of a failure of the relay 36 increases. Therefore, it is preferable to set time T2 at which the switching operation of the cutoff unit 34 to the cutoff state is completed to be earlier than time T4. Specifically, by setting the current threshold Ath to be closer to the first threshold Th1 than to the second threshold Th2, time T2 can be made earlier and the time between time T2 and time T4 can be increased.

### Operation of Control Unit

Next, an example of the operation of the control unit 20 will be described with reference to FIG. 4, etc. The flowchart shown in FIG. 4 represents a process that is repeatedly executed by the control unit 20 when a predetermined start condition is met.

First, in step S1, the start switch (ignition switch) provided on the vehicle is switched from an off state to an on state. The control unit 20 accordingly provides the conduction signal C4 to the relay 36, as a result of which the relay 36 switches from the non-conductive state to the conductive state.

The control unit 20 then advances to step S2, and determines whether the current flowing through the power line 31 is in the current increase state and the voltage in the power line 31 is in the voltage decrease state. Specifically, the control unit 20 determines whether the first detection value A (current value flowing through the power line 31) from the current detection unit 38 is greater than or equal to the current threshold Ath. The control unit 20 also determines whether the second detection value V (voltage value in the power line 31) obtained by the voltage detection unit 39 is less than or equal to the voltage threshold Vth. In step S2, if the first detection value A is less than the current threshold Ath and/or the second detection value Vis greater than the voltage threshold Vth (step S2: No), the control unit 20 determines that the state of the in-vehicle system is not the current increase state and the voltage decrease state. The control unit 20 then repeats step S2. In step S2, if the first detection value A is greater than or equal to the current threshold Ath and the second detection value V is less than or equal to the voltage threshold Vth (step S2: Yes), the control unit 20 determines that the state of the in-vehicle system is state is the current increase state and the voltage decrease state. The control unit 20 then advances to step S3, and outputs the drive signal D to the cutoff unit 34. The process in FIG. 4 then ends.

Next, the effects of this structure will be described.

The cutoff control device 30 is used in the in-vehicle system 10 and configured to control the cutoff unit 34. The in-vehicle system 10 includes the power storage unit 91, the power line 31, and the cutoff unit 34. The power line 31 is a path through which power is transmitted between the power storage unit 91 and the load 94. The cutoff unit 34 is configured to switch from an allowed state in which power supply from the power storage unit 91 to the load 94 through the power line 31 is allowed to a cutoff state in which the power supply is cut off. The cutoff control device 30 includes the current detection unit 38, the voltage detection unit 39, and the control unit 20. The current detection unit 38 is configured to detect the current state of the current flowing through the power line 31. The voltage detection unit 39 is configured to detect the voltage state of the voltage in the power line 31. The control unit 20 is configured to instruct the cutoff unit 34 to switch to the cutoff state if the current state detected by the current detection unit 38 is a predetermined current increase state and the voltage state detected by the voltage detection unit 39 is a predetermined voltage decrease state.

With this structure, the cutoff control device 30 switches the cutoff unit 34 to the cutoff state if both the current increase state and the voltage decrease state are recognized. Thus, the cutoff control device 30 can more accurately determine whether a short-circuit current has occurred, and switch the cutoff unit 34 to the cutoff state upon the occurrence of a short-circuit current. For example, in the case where whether a short-circuit current has occurred is determined based on only a current increase or a voltage decrease, noise or the like may cause erroneous cutoff. The cutoff control device 30 can prevent such erroneous cutoff.

In the cutoff control device 30, the current detection unit 38 is configured to detect the first detection value A with which the current value of the power line 31 is identifiable, as the current increase state. The voltage detection unit 39 is configured to detect the second detection value V with which the voltage value of the power line 31 is identifiable, as the voltage decrease state. The current increase state is a state in which the current value of the power line 31 is greater than or equal to the current threshold Ath, and the voltage decrease state is a state in which the voltage value of the power line 31 is less than or equal to the voltage threshold Vth.

With this structure, the cutoff control device 30 can achieve both protection from short-circuit current and prevention of erroneous cutoff by a simple structure in which whether the current value of the power line 31 is greater than or equal to the current threshold Ath and whether the voltage value of the power line 31 is less than or equal to the voltage threshold Vth are determined based on the first detection value A with which the current value is identifiable and the second detection value V with which the voltage value is identifiable.

The in-vehicle system 10 includes the relay 36 provided in the power line 31 and configured to switch the power line 31 between a conductive state and a non-conductive state. The relay 36 is configured to, if a current greater than or equal to the second threshold Th2 flows through the relay 36 in the conductive state, be released from the conductive state and switch to the non-conductive state due to generation of an electromagnetic repulsive force. The current detection unit 38 in the cutoff control device 30 is configured to detect the first detection value A with which the current value of the power line 31 is identifiable, as the current increase state. The current increase state is a state in which the current value of the power line 31 is greater than or equal to the current threshold Ath, and the current threshold Ath is a value less than the second threshold Th2. With this structure, the cutoff control device 30 can set the current threshold Ath within the range in which switching to the non-conductive state due to an electromagnetic repulsive force does not occur.

The in-vehicle system 10 includes the measurement unit 37 configured to measure the internal resistance value R0 of the power storage unit 91. In the cutoff control device 30, the voltage decrease state is a state in which the voltage value of the power line 31 is less than or equal to the voltage threshold Vth, and the control unit 20 is configured to, based on the internal resistance value R0 measured by the measurement unit 37, set the voltage threshold Vth to be lower when the internal resistance value R0 is larger. With this structure, the cutoff control device 30 can, based on the premise that the internal resistance value R0 of the power storage unit 91 is actually measured, set the voltage threshold Vth according to the actual internal resistance value R0 so that the voltage threshold Vth will be lower when the actual internal resistance value R0 is larger.

In the cutoff control device 30, the voltage decrease state is a state in which the voltage value of the power line 31 is less than or equal to the voltage threshold Vth. Based on a multiplication value and the second detection value V0 (the output voltage of the power storage unit 91), the voltage threshold Vth is determined according to an arithmetic equation that sets the voltage threshold Vth to be higher when the second detection value V0 is larger and to be lower when the multiplication value is larger. The multiplication value is obtained by multiplying the sum of the internal resistance value R0 of the power storage unit 91 and the resistance value Rj of the power line 31 by the current threshold Ath. With this structure, the cutoff control device 30 can appropriately set the voltage threshold Vth by reflecting the internal resistance value R0, the resistance value Rj of the power line 31, the current threshold Ath, and the output voltage of the power storage unit 91.

The in-vehicle system 10 includes the relay 36 provided in the power line 31 and configured to switch the power line 31 between a conductive state and a non-conductive state. In the cutoff control device 30, the voltage detection unit 39 is configured to detect the voltage state on the side closer to the power storage unit 91 than the relay 36. With this structure, the cutoff control device 30 can easily detect the voltage state at a position closer to the power storage unit 91, and therefore can detect the voltage state of the power storage unit 91 while excluding a voltage drop that occurs in the power line 31 as much as possible.

In the cutoff control device 30, a pyrofuse is used in the cutoff unit 34. With this structure, the cutoff control device 30 can easily perform switching to the cutoff state in a short time.

### OTHER EMBODIMENTS

The embodiments disclosed herein are illustrative and not restrictive in all respects. The scope of the present disclosure is not limited to the embodiments disclosed herein but defined by the claims, and is intended to include all modifications within the meaning and scope equivalent to the claims.

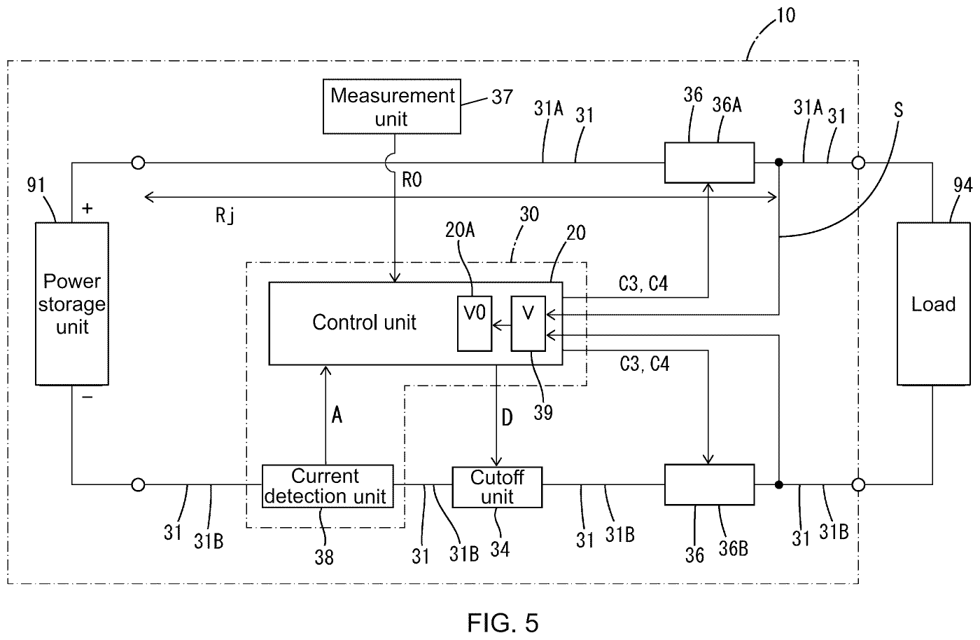

Unlike the configuration disclosed in Embodiment 1, the voltage detection unit 39 may be configured to detect the voltage state on the side closer to the load 94 than the relay 36, as shown in FIG. 5. With this structure, the cutoff control device 30 can suppress the flow of dark current based on the power storage unit 91 to the voltage detection unit 39 when the relay 36 is in the non-conductive state. This leads to power saving. In this case, the resistance value Rj of the power line 31 is larger than that in Embodiment 1.

Unlike the configuration disclosed in Embodiment 1, it may be determined that the state of the in-vehicle system is the voltage decrease state if the voltage decrease rate of the power line is greater than or equal to a certain value. For example, the voltage change amount K in the power line per unit time is calculated according to the following Formula 2.

$$K = ( V - V 0 ) / Δ T \qquad Formula 2$$

where V is the second detection value V currently calculated by the voltage detection unit, V0 is the second detection value V0 previously calculated by the voltage detection unit, and ΔT is the period ΔT with which the voltage detection unit repeatedly calculates the second detection value. In the case where the voltage of the power line decreases over time, V is a value smaller than V0. Therefore, the change amount K is a value smaller than 0 (i.e., a negative value). When the degree by which the voltage of the power line decreases is greater, the change amount K is smaller so as to be farther from 0. For example, a voltage threshold smaller than 0 may be stored in the control unit, and it may be determined that the state of the in-vehicle system is the voltage decrease state if the change amount K is less than the voltage threshold (the voltage decrease rate of the power line is greater than or equal to the certain value). With this structure, the cutoff control device can switch the cutoff unit to the cutoff state when the voltage decrease rate is greater than or equal to the certain value in the current increase state. Thus, the cutoff control device can simultaneously achieve prompt protection from short-circuit current and prevention of erroneous cutoff.

Unlike the configuration disclosed in Embodiment 1, it may be determined that the state of the in-vehicle system is the current increase state if the current increase rate of the power line is greater than or equal to a certain value. For example, the current change amount Ki in the power line per unit time is calculated according to the following Formula 3.

$$Ki = ( A - A 0 ) / Δ T \qquad Formula 3$$

where A is the first detection value A currently detected by the current detection unit, A0 is the first detection value A0 previously detected by the current detection unit, and ΔT is the period ΔT with which the current detection unit repeatedly detects the first detection value. For example, the first detection value A0 may be stored in the storage region 20A. In the case where the current of the power line increases over time, A is a value larger than A0. Therefore, the change amount Ki is a value larger than 0 (i.e., a positive value). When the degree by which the current of the power line increases is greater, the change amount Ki is larger so as to be farther from 0. For example, a current threshold larger than 0 may be stored in the control unit, and it may be determined that the state of the in-vehicle system is the current increase state if the change amount Ki is greater than the current threshold (the current increase rate of the power line is greater than or equal to the certain value).

A comparator may be used as the current detection unit. In this case, a predetermined high-level signal is output when the current value in the power line is greater than or equal to a predetermined threshold, and a predetermined low-level signal is output when the current value is less than the predetermined threshold. A current transformer or the like may also be used.

Unlike the configuration disclosed in Embodiment 1, the cutoff unit may be provided in the high-potential side power line. The current detection unit may be provided in the high-potential side power line. The voltage detection unit may be provided separately from the control unit.

Unlike the configuration disclosed in Embodiment 1, an electromagnetic fuse or a semiconductor switch such as a MOSFET may be used in the cutoff unit. The use of any of these components also enables switching to the cutoff state in a short time.

1. A cutoff control device that is for use in an in-vehicle system including: a power storage unit; a power line as a path through which power is transmitted between the power storage unit and a load; and a cutoff unit configured to switch from an allowed state in which power supply from the power storage unit to the load through the power line is allowed to a cutoff state in which the power supply is cut off, and that is configured to control the cutoff unit, the cutoff control device comprising:
a current detection unit configured to detect a current state of a current flowing through the power line;
a voltage detection unit configured to detect a voltage state of a voltage in the power line; and
a control unit configured to instruct the cutoff unit to switch to the cutoff state if the current state detected by the current detection unit is a predetermined current increase state and the voltage state detected by the voltage detection unit is a predetermined voltage decrease state.

2. The cutoff control device according to claim 1, wherein the current detection unit is configured to detect a first detection value with which a current value of the power line is identifiable, as the current increase state,
the voltage detection unit is configured to detect a second detection value with which a voltage value of the power line is identifiable, as the voltage decrease state,
the current increase state is a state in which the current value of the power line is greater than or equal to a current threshold, and
the voltage decrease state is a state in which the voltage value of the power line is less than or equal to a voltage threshold.

3. The cutoff control device according to claim 1, wherein the in-vehicle system includes a switch provided in the power line and configured to switch the power line between a conductive state and a non-conductive state,
the switch is configured to, if a current greater than or equal to a predetermined value flows through the switch in the conductive state, be released from the conductive state and switch to the non-conductive state due to generation of an electromagnetic repulsive force,
the current detection unit is configured to detect a first detection value with which a current value of the power line is identifiable, as the current increase state,
the current increase state is a state in which the current value of the power line is greater than or equal to a current threshold, and
the current threshold is a value less than the predetermined value.

4. The cutoff control device according to claim 1, wherein the voltage decrease state is a state in which a voltage decrease rate of the power line is greater than or equal to a certain value.

5. The cutoff control device according to claim 1, wherein the in-vehicle system includes a measurement unit configured to measure an internal resistance value of the power storage unit,
the voltage decrease state is a state in which a voltage value of the power line is less than or equal to a voltage threshold, and
the control unit is configured to, based on the internal resistance value measured by the measurement unit, set the voltage threshold to be lower when the internal resistance value is larger.

6. The cutoff control device according to claim 2, wherein the voltage decrease state is a state in which the voltage value of the power line is less than or equal to the voltage threshold, and
based on a multiplication value obtained by multiplying a sum of an internal resistance value of the power storage unit and a resistance value of the power line by the current threshold and an output voltage of the power storage unit, the voltage threshold is determined according to an arithmetic equation that sets the voltage threshold to be higher when the output voltage is larger and to be lower when the multiplication value is larger.

7. The cutoff control device according to claim 1, wherein the in-vehicle system includes a switch provided in the power line and configured to switch the power line between a conductive state and a non-conductive state, and
the voltage detection unit is configured to detect the voltage state on a side closer to the load than the switch.

8. The cutoff control device according to claim 1, wherein the in-vehicle system includes a switch provided in the power line and configured to switch the power line between a conductive state and a non-conductive state, and
the voltage detection unit is configured to detect the voltage state on a side closer to the power storage unit than the switch.

9. The cutoff control device according to claim 1, wherein any of a pyrofuse, an electromagnetic fuse, and a semiconductor switch is used in the cutoff unit.
